(19) United States
(12) Patent Application Publication
(10) Pub. No.: US 2022/0092769 A1
(43) Pub. Date: Mar. 24, 2022

(54) COLLATION APPARATUS, COLLATION METHOD, AND COMPUTER READABLE RECORDING MEDIUM

(71) Applicant: NEC corporation, Minato-ku, Tokyo (JP)

(72) Inventor: Kazuhisa ISHIZAKA, Tokyo (JP)

(73) Assignee: NEC corporation, Minato-ku, Tokyo (JP)

(21) Appl. No.: 17/420,452

(22) PCT Filed: Jan. 17, 2019
(86) PCT No.: PCT/JP2019/001325

§ 371 Date: Jul. 2, 2021

(51) Int. Cl. G06T 7/00; G06V 10/74; G06V 10/77

(52) U.S. Cl. CPC G06T 7/0012; G06T 2207/30201; G06V 10/7715; G06V 10/761

(57) ABSTRACT

A collation apparatus 1 includes: a vector-type arithmetic unit 2 that calculates first similarity degrees using first feature points extracted from a target biological image and second feature points in a plurality of registered biological images, and narrows down the registered biological images based on the calculated first similarity degrees; and an arithmetic unit 3, other than the vector-type arithmetic unit 2, that calculates second similarity degrees using third feature points extracted from the target biological image and fourth feature points in the registered biological images obtained by the narrowing-down, and specifies a registered biological image based on the calculated second similarity degrees.

### TECHNICAL FIELD

The present invention relates to a collation apparatus and collation method in which collation is performed using a vector operation, and further relates to a computer readable recording medium that includes recorded thereon programs for realizing the collation apparatus and collation method.

### BACKGROUND ART

In biometric authentication, exhaustive collation processing is performed using a piece of target biological information and a plurality of pieces of registered biological information, and an individual is identified based on the result of the collation processing. However, it is known that collation processing takes a long time. Thus, a method for reducing the time required for collation processing is proposed.

As a related technique, a system for performing collation processing at high speed is disclosed. According to the system, first, a piece of rough biological information is generated using a piece of target biological information, and a plurality of pieces of registered rough biological information are narrowed down through collation processing using the generated piece of rough biological information and the pieces of registered rough biological information.

Subsequently, the system selects pieces of registered detailed biological information that correspond to the plurality of pieces of registered biological information obtained by the narrowing-down. Then, the system generates a piece of detailed biological information using the piece of target biological information, and identifies an individual by performing collation processing using the generated piece of detailed biological information and the plurality of pieces of registered detailed biological information.

### LIST OF RELATED ART DOCUMENTS

### Patent Document

Patent Document 1: Japanese Patent Laid-Open Publication No. 2004-258963

### SUMMARY

### Technical Problems

Incidentally, it can be inferred that the system disclosed in Patent Document 1 reduces the time required for collation processing by performing collation processing in two stages using software in a server. However, the time required for collation processing depends on the hardware processing speed. Thus, the system disclosed in Patent Document 1 cannot further reduce the time required for collation processing.

An example object of the invention is to provide a collation apparatus, a collation method, and a computer readable recording medium that reduce the time required for collation processing using a vector processor.

### Solutions to the Problems

In order to achieve the above-described object, a collation apparatus according to an example aspect of the invention includes:

a vector-type arithmetic unit configured to calculate first similarity degrees using first feature points extracted from a target biological image and second feature points in a plurality of registered biological images, and narrow down the registered biological images based on the calculated first similarity degrees; and

an arithmetic unit, other than the vector-type arithmetic unit, configured to calculate second similarity degrees using third feature points extracted from the target biological image and fourth feature points in the registered biological images obtained by the narrowing-down, and specify a registered biological image based on the calculated second similarity degrees.

In addition, in order to achieve the above-described object, a collation method according to an example aspect of the invention includes:

(a) a step of using a vector-type arithmetic unit to calculate first similarity degrees using first feature points extracted from a target biological image and second feature points in a plurality of registered biological images, and narrow down the registered biological images based on the calculated first similarity degrees; and

(b) a step of using an arithmetic unit, other than the vector-type arithmetic unit, to calculate second similarity degrees using third feature points extracted from the target biological image and fourth feature points in the registered biological images obtained by the narrowing-down, and specify a registered biological image based on the calculated second similarity degrees.

Furthermore, in order to achieve the above-described object, a computer readable recording medium that includes programs recorded thereon according to an example aspect of the invention includes recorded thereon:

(a) a first program including instructions that cause a vector-type arithmetic unit to carry out a step of calculating first similarity degrees using first feature points extracted from a target biological image and second feature points in a plurality of registered biological images, and narrowing down the registered biological images based on the calculated first similarity degrees; and

(b) a second program including instructions that cause an arithmetic unit, other than the vector-type arithmetic unit, to carry out a step of calculating second similarity degrees using third feature points extracted from the target biological image and fourth feature points in the registered biological images obtained by the narrowing-down, and specifying a registered biological image based on the calculated second similarity degrees.

### Advantageous Effects of the Invention

As described above, according to the invention, the time required for collation processing can be reduced using a vector processor.

### BRIEF DESCRIPTION OF THE DRAWINGS

FIG. 1 is a diagram illustrating one example of a collation apparatus.

FIG. 2 is a diagram illustrating one example of a system including the collation apparatus.

FIG. 3 is a diagram illustrating one example of data structures of first and second feature point information.

FIG. 4 is a diagram illustrating one example of a code used for a vector operation.

FIG. 5 is a diagram illustrating one example of data structures of third and fourth feature point information.

FIG. 6 is a diagram illustrating one example of operations of the collation apparatus.

FIG. 7 is a diagram for describing a modification.

FIG. 8 is a diagram illustrating one example of computers for realizing the collation apparatus.

### EXAMPLE EMBODIMENT

### Example Embodiment

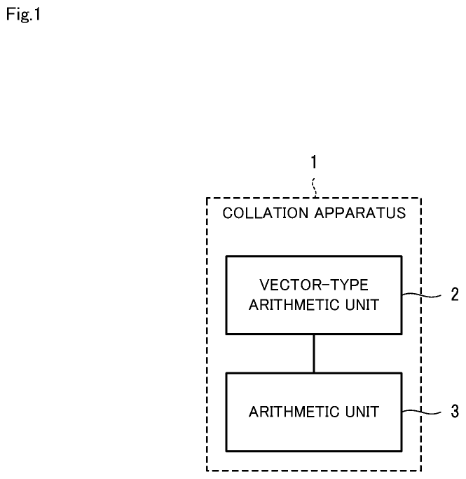

In the following, an example embodiment of the invention will be described with reference to FIGS. 1 to 8.

[Apparatus Configuration]

First, a configuration of a collation apparatus 1 in the present example embodiment will be described with reference to FIG. 1. FIG. 1 is a diagram illustrating one example of the collation apparatus.

The collation apparatus illustrated in FIG. 1 is an apparatus that reduces the time required for collation processing using a vector-type arithmetic unit. Furthermore, as illustrated in FIG. 1, the collation apparatus 1 includes a vector-type arithmetic unit 2 and an arithmetic unit 3 other than a vector-type arithmetic unit.

Of the arithmetic units, the vector-type arithmetic unit 2 calculates first similarity degrees using feature points (first feature points) extracted from a target biological image and feature points (second feature points) in a plurality of registered biological images, and narrows down the registered biological images based on the calculated first similarity degrees.

The arithmetic unit 3 is an arithmetic unit other than the vector-type arithmetic unit 2, and calculates second similarity degrees using feature points (third feature points) extracted from the target biological image and feature points (fourth feature points) in the registered biological images obtained by the narrowing-down, and specifies a registered biological image based on the calculated second similarity degrees.

Here, the vector-type arithmetic unit 2, for example, is an arithmetic unit that can perform a vector operation, in which the same operation is simultaneously executed on a plurality of pieces of data. For example, the vector-type arithmetic unit 2 is a vector processor or the like. The arithmetic unit 3 is a conventional processor or the like. Furthermore, the arithmetic unit 3, for example, is a processor, a scalar-type arithmetic unit, or the like that has a lower vector operation performance than the vector-type arithmetic unit 2.

The target biological image is an image obtained by capturing an image of a part of a living body using an image capturing apparatus. For example, the part of the living body is the face, a fingerprint, an iris, a vein, a palm, or the like. The registered biological images are images obtained by capturing, in advance, images of the part of the living body of a plurality of users using an image capturing apparatus. Furthermore, the registered biological images are stored in a storage unit that is not illustrated. The storage unit may be provided inside or outside the collation apparatus 1. Note that the storage unit is a storage device, such as a database, or the like, for example.

The first feature points are feature points that are used in the vector-type arithmetic unit 2, and are feature points extracted from the target biological image, which is obtained by capturing an image of the part of the living body of a target user. The second feature points are feature points that are used in the vector-type arithmetic unit 2, and are feature points obtained by capturing images of the part of the living body of a plurality of users and extracting feature points from the captured biological images.

The third feature points are feature points that are used in the arithmetic unit 3 other than the vector-type arithmetic unit 2, and are feature points extracted from the target biological image, which is obtained by capturing an image of the part of the living body of the target user. Note that the third feature points may include the first feature points.

The fourth feature points are feature points in the registered biological images obtained by the narrowing-down performed by the vector-type arithmetic unit 2, and are feature points that are used in the arithmetic unit 3 other than the vector-type arithmetic unit 2. Furthermore, the fourth feature points are feature points obtained by capturing images of the part of the living body of the plurality of users and extracting feature points from the captured biological images. Note that the fourth feature points may include the second feature points.

For example, in a case in which the collation processing is performed in fingerprint authentication, first similarity degrees are calculated by the vector-type arithmetic unit 2 using feature amounts of first feature points of a fingerprint extracted from a target biological image obtained by capturing an image of a target fingerprint and feature amounts of second feature points of fingerprints extracted from registered biological images obtained by capturing images of fingerprints.

For example, in a case in which the collation processing is performed in fingerprint authentication, second similarity degrees are calculated by the arithmetic unit 3 other than the vector-type arithmetic unit 2 using feature amounts of third feature points of the fingerprint extracted from the target biological image obtained by capturing an image of the target fingerprint and feature amounts of fourth feature points of fingerprints extracted from the registered biological images that are obtained by the narrowing-down, which are obtained by capturing images of fingerprints.

Note that the first to fourth feature points described above correspond to the center of a fingerprint pattern (center point), branching in a fingerprint ridge pattern (bifurcation point), a dead end in a fingerprint ridge pattern (end point), merging from three directions (delta), and the like in the case of fingerprint authentication, for example. For example, feature amounts include feature point types, feature point orientations (inclination: angle), the distances from the center point to feature points, etc. Note that the curvature of a curved line that a fingerprint exhibits, the line spacing between fingerprint ridges, and the like may be used as feature amounts.

As described above, the time required for collation processing in biometric authentication can be reduced in the present example embodiment since a vector operation is executed using hardware such as the vector-type arithmetic unit 2 and registered biological images can be narrowed down at high speed.

[System Configuration]

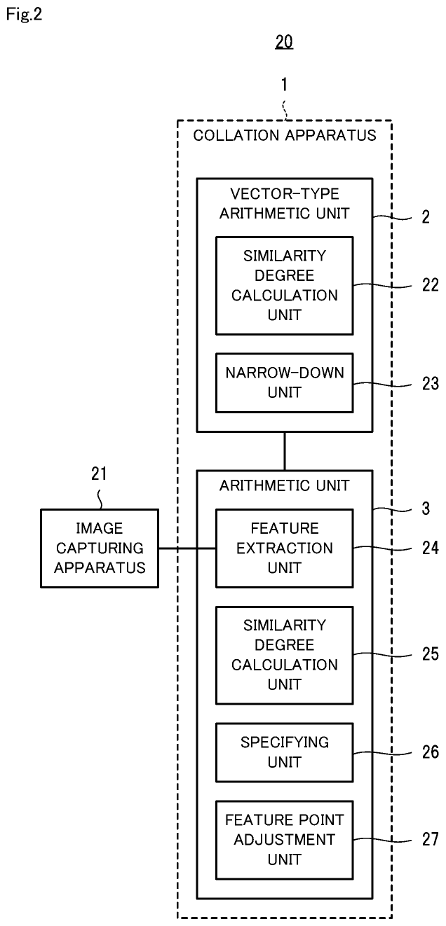

Next, the configuration of the collation apparatus 1 in the present example embodiment will be more specifically described with reference to FIG. 2. FIG. 2 is a diagram illustrating one example of a system including the collation apparatus.

As illustrated in FIG. 2, a system 20 including the collation apparatus 1 in the present example embodiment includes the collation apparatus 1 and an image capturing apparatus 21. The collation apparatus 1 includes the vector-type arithmetic unit 2 and the arithmetic unit 3. The vector-type arithmetic unit 2 includes a similarity degree calculation unit 22 and a narrow-down unit 23. The arithmetic unit 3 includes a feature extraction unit 24, a similarity degree calculation unit 25, a specifying unit 26, and a feature point adjustment unit 27. Note that the system 20 is a biometric authentication device or the like, for example.

The image capturing apparatus 21 transmits, to the collation apparatus 1 connected thereto, images obtained by capturing images of the part of the living body. For example, the image capturing apparatus 21 is a charge-coupled device (CCD) camera, a complementary metal—oxide—semiconductor (CMOS) camera, or the like, and the image capturing apparatus 21 may be any image capturing apparatus that can capture images of the part of the living body.

The vector-type arithmetic unit will be described in detail.

The vector-type arithmetic unit 2 performs first collation using the similarity degree calculation unit 22 and the narrow-down unit 23 and narrows down registered biological images.

The similarity degree calculation unit 22, by means of a vector operation function of the vector-type arithmetic unit 2, calculates first similarity degrees using feature point information indicating first feature points and feature point information indicating second feature points in registered biological images.

Specifically, the similarity degree calculation unit 22 first acquires, from the feature extraction unit 24, feature point information indicating first feature points extracted from a target biological image.

Subsequently, the similarity degree calculation unit 22 selects one of a plurality of registered biological images registered in advance in the storage unit, and acquires feature point information indicating second feature points corresponding to the selected registered biological image. That is, the similarity degree calculation unit 22 acquires, from the storage unit, feature point information indicating second feature points extracted in advance from the selected registered biological image.

Subsequently, the similarity degree calculation unit 22 calculates a first similarity degree using the feature point information indicating the first feature points and the acquired feature point information indicating the second feature points.

Subsequently, the similarity degree calculation unit 22 selects a subsequent registered biological image, and calculates a first similarity degree between the target biological image and the selected registered biological image. In such a manner, for each registered biological image, the similarity degree calculation unit 22 calculates a first similarity degree between the registered biological image and the target biological image.

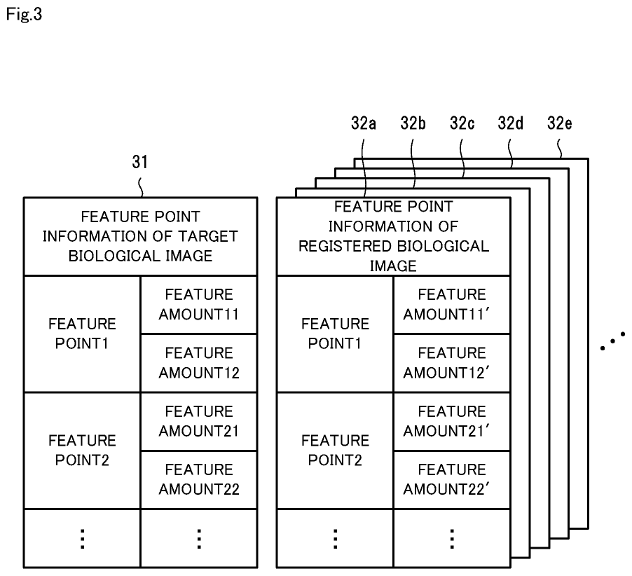

The similarity degree calculation unit 22 will be described in detail with reference to FIG. 3. FIG. 3 is a diagram illustrating one example of data structures of first and second feature point information.

The similarity degree calculation unit 22 first acquires, from the later-described feature extraction unit 24, feature point information 31 indicating first feature points extracted from the target biological image as illustrated in FIG. 3. Subsequently, the similarity degree calculation unit 22 acquires feature point information 32a indicating second feature points extracted from a registered biological image as illustrated in FIG. 3, which is registered in the storage unit in advance. Then, the similarity degree calculation unit 22 calculates a first similarity degree using the feature point information 31 and the feature point information 32a.

Subsequently, when the calculation of the first similarity degree between the feature point information 31 and the feature point information 32a is completed, the similarity degree calculation unit 22 then acquires feature point information 32b and calculates a first similarity degree between the feature point information 31 and the feature point information 32b using the feature point information 31 and the feature point information 32b. Similarly, for each of feature point information 32c, 32d, 32e, , the similarity degree calculation unit 22 calculates a first similarity degree between the feature point information and the feature point information 31.

The first similarity degrees will be described. For example, a case in which feature amounts of feature points include feature amounts (11, 21, . . . , 11′, 21′, . . . ) indicating the orientations of the feature points and feature amounts (12, 22, . . . , 12′, 22′, . . . ) indicating the distances from the center point to the feature points will be described.

For example, the first similarity degree between the feature point information 31 and the feature point information 32a is calculated as follows. For each feature amount (11, 12, 21, 22, . . . ) included in the feature point information 31, the difference (11−11′, 12−12′, 21−21′, 22−22′, . . . ) between the feature amount and a corresponding feature amount (11′, 12′, 21′, 22′, . . . ) included in the feature point information 32a is calculated, and the total of the calculated differences is set as the first similarity degree (|11−11′|+|12−12′|+|21−21′+|22−22′|+, . . . ).

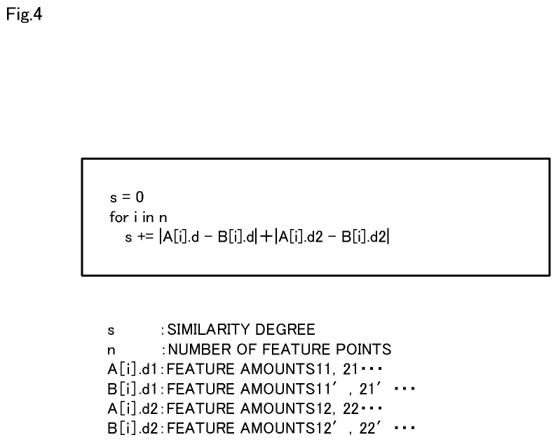

FIG. 4 is a diagram illustrating one example of a code used for the vector operation. The code illustrated in FIG. 4 is used in a case in which the above-described first similarity degrees are calculated. In a case in which the first similarity degree between the feature point information 31 and the feature point information 32a is calculated, the feature amounts (11, 21, . . . ) indicating the orientations of the feature points in the feature point information 31 are indicated using a matrix A[i]d1 and the feature amounts (11′, 21′, . . . ) indicating the orientations of the feature points in the feature point information 32a are indicated using a matrix B[i]d1 in the code in FIG. 4. Furthermore, the feature amounts (12, 22, . . . ) indicating the distances from the center point to the feature points in the feature point information 31 are indicated using a matrix A[i]d2 and the feature amounts (11′, 21′, . . . ) indicating the distances from the center point to the feature points in the feature point information 32a are indicated using a matrix B[i]d2.

Note that, also for each of the feature point information 32b, 32c, 32d, 32e , . . . , a first similarity degree between the feature point information and the feature point information 31 is calculated using a similar method.

In such a manner, the calculation of similarity degrees between the target biological image and registered biological images can be executed at high speed using the vector operation function of the vector-type arithmetic unit 2.

Furthermore, a first similarity degree can be calculated separately for each type of feature amount. Specifically, a first similarity degree (|11−11′|+|21−21′|+ . . . ) corresponding to the orientations of feature points and a first similarity degree (|12−12′|+|22−22 ′+ . . . ) corresponding to the distances from the center point to the feature points may be separately calculated.

The narrow-down unit 23 narrows down the registered biological images based on the calculated first similarity degrees. Specifically, if first similarity degrees are within a preset narrow-down range, the narrow-down unit 23 extracts registered biological images having first similarity degrees within the narrow-down range. The narrow-down range is determined through experimentation, simulation, etc.

In addition, in a case in which separate first similarity degrees are calculated as described above, a narrow-down range is set in advance for each first similarity degree. Furthermore, for each first similarity degree, the narrow-down unit 23 extracts registered biological images using the corresponding narrow-down range.

In such a manner, registered biological images can be narrowed down at high speed using the vector operation function of the vector-type arithmetic unit 2. Thus, the time required for collation processing used in biometric authentication, etc., can be reduced.

The arithmetic unit other than the vector-type arithmetic unit will be described in detail.

The arithmetic unit 3 performs second collation using the similarity degree calculation unit 25 and the specifying unit 26 and specifies a biological image similar to the target biological image from among the registered biological images obtained by the narrowing-down.

The feature extraction unit 24 extracts feature points from the target biological image. Specifically, the feature extraction unit 24 first acquires the target biological image acquired from the image capturing apparatus 21, and extracts the first feature points using the acquired target biological image. Subsequently, the feature extraction unit 24 transmits the feature point information indicating the extracted first feature points to the vector-type arithmetic unit 2.

Furthermore, the feature extraction unit 24 acquires the target biological image acquired from the image capturing apparatus 21, and extracts third feature points using the acquired target biological image. Subsequently, the feature extraction unit 24 transmits feature point information indicating the extracted third feature points to the arithmetic unit 3. The third feature points may include the first feature points. Note that the feature extraction unit 24 may generate the third feature points from the first feature points.

Note that, while the feature extraction unit 24 is provided in the arithmetic unit 3 in the system illustrated in FIG. 2, the feature extraction unit 24 may be provided in a processor or the like other than the arithmetic unit 3.

The similarity degree calculation unit 25 calculates second similarity degrees using the feature point information indicating the third feature points and feature point information indicating fourth feature points in the registered biological images obtained by the narrowing-down.

Specifically, the similarity degree calculation unit 25 first acquires, from the feature extraction unit 24, the feature point information indicating the third feature points extracted from the target biological image.

Subsequently, the similarity degree calculation unit 25 selects one of the registered biological images obtained by the narrowing-down, and acquires feature point information indicating fourth feature points corresponding to the selected registered biological image. That is, the similarity degree calculation unit 25 acquires, from the storage unit, feature point information indicating fourth feature points extracted in advance from the selected registered biological image.

Subsequently, the similarity degree calculation unit 25 calculates a second similarity degree using the feature point information indicating the third feature points and the acquired feature point information indicating the fourth feature points.

Subsequently, the similarity degree calculation unit 25 selects a subsequent registered biological image from among the registered biological images obtained by the narrowing-down, and calculates a second similarity degree between the target biological image and the selected registered biological image. In such a manner, for each selected registered biological image, the similarity degree calculation unit 25 calculates a second similarity degree between the registered biological image and the target biological image.

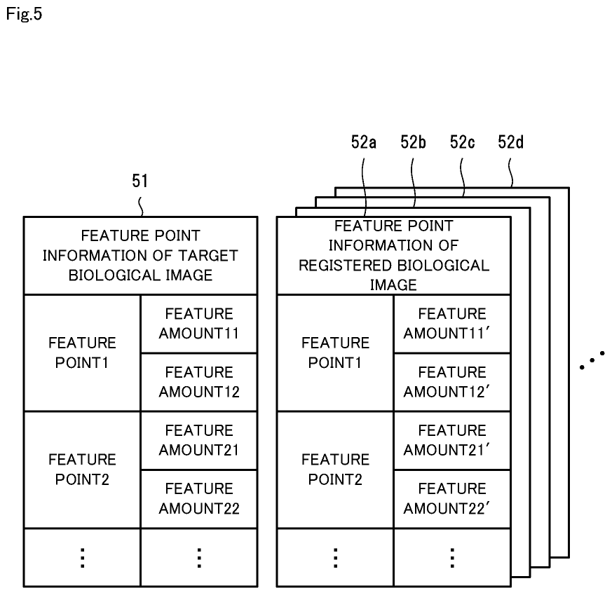

The similarity degree calculation unit 25 will be described in detail with reference to FIG. 5. FIG. 5 is a diagram illustrating one example of data structures of third and fourth feature point information.

The similarity degree calculation unit 25 first acquires, from the feature extraction unit 24, feature point information 51 indicating third feature points extracted from the target biological image as illustrated in FIG. 5. Subsequently, the similarity degree calculation unit 25 acquires feature point information 52a indicating fourth feature points from a registered biological image obtained by the narrowing-down performed by the narrow-down unit 23 as illustrated in FIG. 5. The fourth feature points may include the second feature points. Note that the similarity degree calculation unit 25 may acquire the second feature points and generate the fourth feature points from the second feature points.

Then, the similarity degree calculation unit 25 calculates a second similarity degree using the feature point information 51 and the feature point information 52a. Subsequently, when the calculation of the second similarity degree between the feature point information 51 and the feature point information 52a is completed, the similarity degree calculation unit 25 then acquires feature point information 52b and calculates a second similarity degree between the feature point information 51 and the feature point information 52b using the feature point information 51 and the feature point information 52b. Similarly, for each of feature point information 52c, 52d , . . . , the similarity degree calculation unit 25 calculates a second similarity degree between the feature point information and the feature point information 51.

The second similarity degrees will be described. For example, a case in which feature amounts of feature points include feature amounts (11, 21, . . . , 11′, 21′, . . . ) indicating the orientations of the feature points and feature amounts (12, 22, . . . , 12′, 22′, . . . ) indicating the distances from the center point to the feature points will be described.

For example, the second similarity degree between the feature point information 51 and the feature point information 52a is calculated as follows. For each feature amount (11, 12, 21, 22, . . . ) included in the feature point information 51, the difference (11−11′, 12−12′, 21−21′, 22−22′, . . . ) between the feature amount and a corresponding feature amount (11′, 12′, 21′, 22′, . . . ) included in the feature point information 52a is calculated, and the total of the calculated differences is set as the second similarity degree (|11−11′|+|12−12′|+|21−21 |+|22−22′|+ . . . ).

Note that, also for each of the feature point information 52b, 52c, 52d , . . . , a second similarity degree is calculated in a similar manner.

The specifying unit 26 specifies a registered biological image based on the calculated second similarity degrees. Specifically, the specifying unit 26 specifies a registered biological image having a high second similarity degree, i.e., a registered biological image similar to the target biological image, from among the registered biological images that are obtained by the narrowing-down.

The feature point adjustment unit 27 adjusts the number of first feature points. Specifically, the feature point adjustment unit 27 adjusts the time required for the calculation of the first similarity degrees executed by the vector-type arithmetic unit 2 by adjusting the number of first feature points used to calculate the first similarity degrees. For example, the feature point adjustment unit 27 adjusts the number of first feature points so that the total time required to calculate the first and second similarity degrees is minimized or so that the calculation is completed within a predetermined amount of time.

That is, by narrowing down the registered biological images in a state in which many feature points are used to calculate the first similarity degrees, the number of registered biological images used to calculate the second similarity degrees is reduced and the time required to calculate the second similarity degrees is reduced. Furthermore, if the registered biological images are narrowed down in a state in which fewer feature points are used to calculate the first similarity degrees, the time required to calculate the second similarity degrees increases. Note that the feature point adjustment unit 27 may adjust the number of second feature points.

Furthermore, the feature point adjustment unit 27 may adjust the number of feature amounts that the first feature points have. By adjusting the number of feature amounts, the feature point adjustment unit 27 adjusts the time required for the calculation of the first similarity degrees executed by the vector-type arithmetic unit 2. For example, the feature point adjustment unit 27 adjusts the number of feature amounts that the first feature points have so that the total time required to calculate the first and second similarity degrees is minimized or so that the calculation is completed within a predetermined amount of time.

Note that, while the feature point adjustment unit 27 is provided in the arithmetic unit 3 in the system illustrated in FIG. 2, the feature point adjustment unit 27 may be provided in a processor other than the arithmetic unit 3.

[Apparatus Operations]

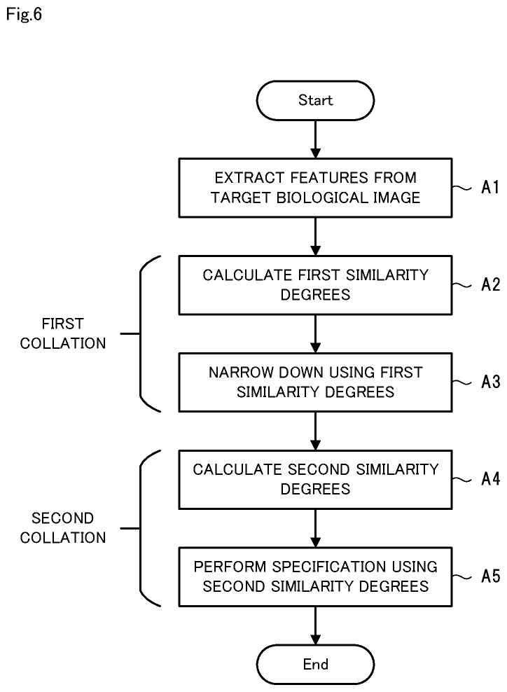

Next, operations of the collation apparatus in the example embodiment of the invention will be described with reference to FIG. 6. FIG. 6 is a diagram illustrating one example of operations of the collation apparatus. FIGS. 1 to 5 will be referred to as needed in the following description. Furthermore, in the present example embodiment, a collation method is implemented by causing the collation apparatus to operate. Accordingly, the following description of the operations of the collation apparatus is substituted for the description of the collation method in the present example embodiment.

As illustrated in FIG. 6, first, the feature extraction unit 24 extracts feature points from a target biological image (step A1). Specifically, in step A1, the feature extraction unit 24 first acquires a target biological image acquired from the image capturing apparatus 21, and extracts first feature points using the acquired target biological image. Subsequently, the feature extraction unit 24 transmits feature point information indicating the extracted first feature points to the vector-type arithmetic unit 2.

Subsequently, the similarity degree calculation unit 22, by means of a vector operation function of the vector-type arithmetic unit 2, calculates first similarity degrees using the feature point information indicating the first feature points and feature point information indicating second feature points in registered biological images (step A2).

Specifically, in step A2, the similarity degree calculation unit 22 first acquires, from the feature extraction unit 24, the feature point information indicating the first feature points extracted from the target biological image.

Subsequently, in step A2, the similarity degree calculation unit 22 selects one of a plurality of registered biological images registered in advance in the storage unit, and acquires feature point information indicating second feature points corresponding to the selected registered biological image. That is, the similarity degree calculation unit 22 acquires, from the storage unit, feature point information indicating second feature points extracted in advance from the selected registered biological image.

Subsequently, in step A2, the similarity degree calculation unit 22 calculates a first similarity degree using the feature point information indicating the first feature points and the acquired feature point information indicating the second feature points.

Subsequently, in step A2, the similarity degree calculation unit 22 selects a subsequent registered biological image, and calculates a first similarity degree between the target biological image and the selected registered biological image. In such a manner, for each registered biological image, the similarity degree calculation unit 22 calculates a first similarity degree between the registered biological image and the target biological image.

Accordingly, in step A2, the calculation of similarity degrees between the target biological image and registered biological images can be executed at high speed using the vector operation function of the vector-type arithmetic unit 2.

Furthermore, a first similarity degree can be calculated separately for each type of feature amount in step A2. Specifically, a first similarity degree corresponding to the orientations of feature points and a first similarity degree corresponding to the distances from the center point to the feature points may be separately calculated.

Subsequently, the narrow-down unit 23 narrows down the registered biological images based on the calculated first similarity degrees (step A3).

Specifically, in step A3, if first similarity degrees are within a preset narrow-down range, the narrow-down unit 23 extracts registered biological images having first similarity degrees within the narrow-down range. The narrow-down range is determined through experimentation, simulation, etc.

In addition, in a case in which separate first similarity degrees are calculated as described above, a narrow-down range is set in advance for each first similarity degree. Furthermore, for each first similarity degree, the narrow-down unit 23 extracts registered biological images using the corresponding narrow-down range.

In such a manner, in step A3, registered biological images can be narrowed down at high speed using the vector operation function of the vector-type arithmetic unit 2. Thus, the time required for collation processing used in biometric authentication, etc., can be reduced.

Subsequently, the similarity degree calculation unit 25 calculates second similarity degrees using feature point information indicating third feature points and feature point information indicating fourth feature points in the registered biological images obtained by the narrowing-down (step A4).

Specifically, in step A4, the similarity degree calculation unit 25 first acquires, from the feature extraction unit 24, feature point information indicating third feature points extracted from the target biological image.

Subsequently, in step A4, the similarity degree calculation unit 25 selects one of the registered biological images obtained by the narrowing-down, and acquires feature point information indicating fourth feature points corresponding to the selected registered biological image. That is, the similarity degree calculation unit 25 acquires, from the storage unit, feature point information indicating fourth feature points extracted in advance from the selected registered biological image.

Subsequently, in step A4, the similarity degree calculation unit 25 calculates a second similarity degree using the feature point information indicating the third feature points and the acquired feature point information indicating the fourth feature points.

Subsequently, in step A4, the similarity degree calculation unit 25 selects a subsequent registered biological image from among the registered biological images obtained by the narrowing-down, and calculates a second similarity degree between the target biological image and the selected registered biological image. In such a manner, for each selected registered biological image, the similarity degree calculation unit 25 calculates a second similarity degree between the registered biological image and the target biological image.

Subsequently, the specifying unit 26 specifies a registered biological image based on the calculated second similarity degrees (step A5). Specifically, in step A5, the specifying unit 26 specifies a registered biological image having a high second similarity degree, i.e., a registered biological image similar to the target biological image, from among the registered biological images that are obtained by the narrowing-down.

Note that, in step A2, the number of first feature points may be adjusted using the feature point adjustment unit 27. Specifically, the feature point adjustment unit 27 adjusts the time required for the calculation of the first similarity degrees executed by the vector-type arithmetic unit 2 by adjusting the number of first feature points used to calculate the first similarity degrees. For example, the feature point adjustment unit 27 adjusts the number of first feature points so that the total time required to calculate the first and second similarity degrees is minimized or so that the calculation is completed within a predetermined amount of time.

That is, by narrowing down the registered biological images in a state in which many feature points are used to calculate the first similarity degrees, the number of registered biological images used to calculate the second similarity degrees is reduced and the time required to calculate the second similarity degrees is reduced. Furthermore, if the registered biological images are narrowed down in a state in which fewer feature points are used to calculate the first similarity degrees, the time required to calculate the second similarity degrees increases. Note that the feature point adjustment unit 27 may adjust the number of second feature points.

Furthermore, the feature point adjustment unit 27 may adjust the number of feature amounts that the first feature points have. By adjusting the number of feature amounts, the feature point adjustment unit 27 adjusts the time required for the calculation of the first similarity degrees executed by the vector-type arithmetic unit 2. For example, the feature point adjustment unit 27 adjusts the number of feature amounts that the first feature points have so that the total time required to calculate the first and second similarity degrees is minimized or so that the calculation is completed within a predetermined amount of time.

Note that, while the feature point adjustment unit 27 is provided in the arithmetic unit 3 in the system illustrated in FIG. 2, the feature point adjustment unit 27 may be provided in a processor other than the arithmetic unit 3.

### Effects of Example Embodiment

As described above, according to the present example embodiment, the time required for collation processing in biometric authentication can be reduced since registered biological images can be narrowed down at high speed by executing a vector operation using hardware such as the vector-type arithmetic unit 2.

[Program]

suffices for a first program in the example embodiment of the invention to be a program that causes a computer including a vector processor such as the vector-type arithmetic unit 2 to carry out steps A2 and A3 shown in FIG. 6. Furthermore, it suffices for a second program in the example embodiment of the invention to be a program that causes a computer including a conventional processor such as the arithmetic unit 3 to carry out steps Al, A4, and A5 shown in FIG. 6.

By installing the first program on a computer including a vector processor such as the vector-type arithmetic unit 2 and executing the second program using a computer including a conventional processor such as the arithmetic unit 3, the collation apparatus and the collation method in the present example embodiment can be realized.

In this case, the computer including the vector processor functions and performs processing as the similarity degree calculation unit 22 and the narrow-down unit 23. Furthermore, the computer including the conventional processor functions and performs processing as the feature extraction unit 24, the similarity degree calculation unit 25, the specifying unit 26, and the feature point adjustment unit 27.

Furthermore, in the present example embodiment, the program to be used by a conventional processor may be executed by a system constructed using a plurality of conventional processors. In this case, the processors may each function as one of the feature extraction unit 24, the similarity degree calculation unit 25, the specifying unit 26, and the feature point adjustment unit 27, for example.

Note that the function of the feature point adjustment unit 27 may be configured as a separate program from the second program and may be executed by a processor other than the arithmetic unit 3.

[Modification]

In this modification, the collation apparatus 1 causes the first and second collations described above to be executed sequentially for individual groups into which registered biological images are divided.

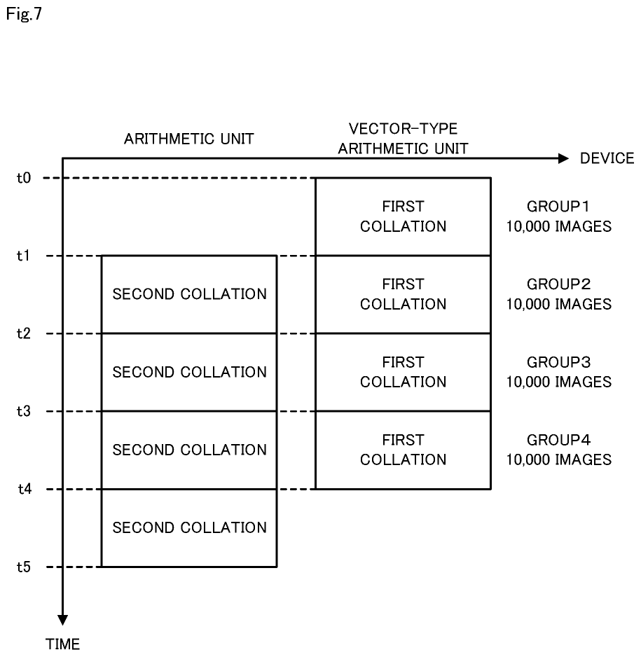

The modification will be described with reference to FIG. 7. FIG. 7 is a diagram for describing the modification. For example, a case in which there are 40,000 registered biological images in total and the registered biological images are divided into four groups each including 10,000 images will be described.

The collation apparatus 1 first performs the first collation on the 10,000 images in group 1 from time t0 to time t1. Subsequently, from time t1 to time t2, the collation apparatus 1 performs the second collation on the registered images obtained by narrowing down the 10,000 images in group 1, and performs the first collation on the 10,000 images in group 2.

Subsequently, from time t2 to time t3, the collation apparatus 1 performs the second collation on the registered images obtained by narrowing down the 10,000 images in group 2, and performs the first collation on the 10,000 images in group 3. Subsequently, from time t3 to time t4, the collation apparatus 1 performs the second collation on the registered images obtained by narrowing down the 10,000 images in group 3, and performs the first collation on the 10,000 images in group 4. Then, from time t4 to time t5, the collation apparatus 1 performs the second collation on the registered images obtained by narrowing down the 10,000 images in group 4.

According to the modification, the time required for collation processing used in biometric authentication, etc., can be reduced since the narrowing-down of registered biological images and the specification of a registered biological image can be processed in parallel by causing the vector-type arithmetic unit 2 and the arithmetic unit 3 to operate in parallel.

[Physical Configuration]

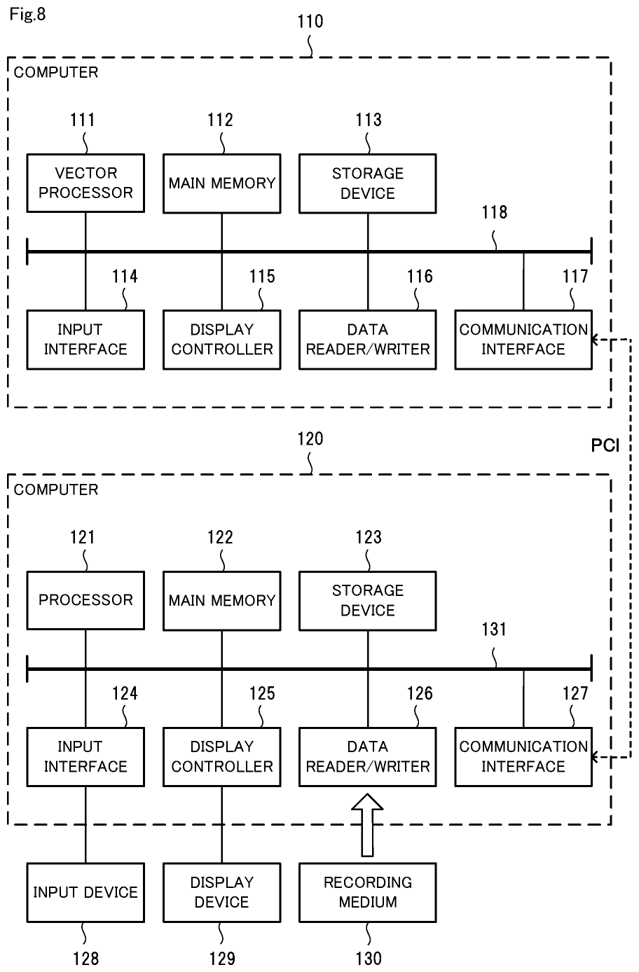

Here, a computer including a vector processor such as the vector-type arithmetic unit 2 and a computer including a conventional processor such as the arithmetic unit 3 that realize the collation apparatus by executing the first and second programs in the example embodiment will be described with reference to FIG. 8. FIG. 8 is a block diagram illustrating one example of computers realizing the collation apparatus in the example embodiment of the invention.

In the case of a computer including a vector processor, a computer 110 includes a vector processor 111, a main memory 112, a storage device 113, an input interface 114, a display controller 115, a data reader/writer 116, and a communication interface 117, as illustrated in FIG. 8. These components are connected via a bus 118 so as to be capable of performing data communication with one another.

The vector processor 111 loads the first program (codes) in the present example embodiment, which is stored in the storage device 113, onto the main memory 112, and performs various computations by executing these codes in a predetermined order. The main memory 112 is typically a volatile storage device such as a dynamic random access memory (DRAM). Furthermore, the first program in the present example embodiment is provided in a state such that the first program is stored in a computer readable recording medium. Note that the first program in the present example embodiment may be a program that is distributed on the Internet, to which the computer 110 is connected via the communication interface 117.

In addition, specific examples of the storage device 113 include semiconductor storage devices such as a flash memory, in addition to hard disk drives. The input interface 114 mediates data transmission between the vector processor 111 and input equipment such as a keyboard and a mouse. The display controller 115 is connected to a display device 119, and controls the display performed by the display device 119.

The data reader/writer 116 mediates data transmission between the vector processor 111 and the recording medium, and executes the reading out of the first program from the recording medium and the writing of results of processing in the computer 110 to the recording medium. The communication interface 117 mediates data transmission between the vector processor 111 and other computers. For example, a Peripheral Component Interconnect (PCI) bus, etc., are conceivable as the communication interface 117.

Furthermore, specific examples of the recording medium include a general-purpose semiconductor storage device such as a CompactFlash (registered trademark, CF) card or a Secure Digital (SD) card, a magnetic recording medium such as a flexible disk, and an optical recording medium such as a compact disk read-only memory (CD-ROM).

Subsequently, in the case of a computer including a conventional processor such as the arithmetic unit 3, a computer 120 includes a processor 121, a main memory 122, a storage device 123, an input interface 124, a display controller 125, a data reader/writer 126, and a communication interface 127, as illustrated in FIG. 8. These components are connected via a bus 131 so as to be capable of performing data communication with one another. Note that the computer 120 may include a graphics processing unit (GPU) or a field-programmable gate array (FPGA) in addition to the processor 121 or in place of the processor 121.

The computer 120 loads the second program (codes) in the present example embodiment, which is stored in the storage device 123, onto the main memory 122, and performs various computations by executing these codes in a predetermined order. The main memory 122 is typically a volatile storage device such as a dynamic random access memory (DRAM).

Furthermore, the second program in the present example embodiment is provided in a state such that the second program is stored in a computer readable recording medium 130. In addition, the recording medium 130 may include the first program and the second program stored thereon. Note that the second program in the present example embodiment may be a program that is distributed on the Internet, to which the computer 120 is connected via the communication interface 127.

In addition, specific examples of the storage device 123 include semiconductor storage devices such as a flash memory, in addition to hard disk drives. The input interface 124 mediates data transmission between the computer 120 and input equipment 128 such as a keyboard and a mouse. The display controller 125 is connected to a display device 129, and controls the display performed by the display device 129.

The data reader/writer 126 mediates data transmission between the computer 120 and the recording medium 130, and executes the reading out of the second program from the recording medium 130 and the writing of results of processing in the computer 120 to the recording medium 130. The communication interface 127 mediates data transmission between the computer 120 and other computers. For example, a PCI bus, etc., are conceivable as the communication interface 127.

Furthermore, specific examples of the recording medium 130 include a general-purpose semiconductor storage device such as a CF card or an SD card, a magnetic recording medium such as a flexible disk, and an optical recording medium such as a CD-ROM.

Note that the computer 120 having the second program installed thereon can also be realized by using pieces of hardware corresponding to the respective units. Furthermore, a portion of the collation apparatus 1 may be realized by using the second program, and the remaining portion of the collation apparatus 1 may be realized by using hardware.

[Supplementary Note]

In relation to the above example embodiment, the following supplementary notes are further disclosed. While a part of or the entirety of the above-described example embodiment can be expressed by (Supplementary note 1) to (Supplementary note 12) described in the following, the invention is not limited to the following description.

(Supplementary Note 1)

A collation apparatus including:

a vector-type arithmetic unit configured to calculate first similarity degrees using first feature points extracted from a target biological image and second feature points in a plurality of registered biological images, and narrow down the registered biological images based on the calculated first similarity degrees; and

an arithmetic unit, other than the vector-type arithmetic unit, configured to calculate second similarity degrees using third feature points extracted from the target biological image and fourth feature points in the registered biological images obtained by the narrowing-down, and specify a registered biological image based on the calculated second similarity degrees.

(Supplementary Note 2)

The collation apparatus according to Supplementary note 1, further including a feature point adjustment unit configured to adjust the number of first feature points.

(Supplementary Note 3)

The collation apparatus according to Supplementary note 2, wherein the arithmetic unit includes the feature point adjustment unit.

(Supplementary Note 4)

The collation apparatus according to any one of Supplementary notes 1 to 3, wherein the collation apparatus is used for biometric authentication.

(Supplementary Note 5)

A collation method including:

(a) a step of using a vector-type arithmetic unit to calculate first similarity degrees using first feature points extracted from a target biological image and second feature points in a plurality of registered biological images, and narrow down the registered biological images based on the calculated first similarity degrees; and

(b) a step of using an arithmetic unit, other than the vector-type arithmetic unit, to calculate second similarity degrees using third feature points extracted from the target biological image and fourth feature points in the registered biological images obtained by the narrowing-down, and specify a registered biological image based on the calculated second similarity degrees.

(Supplementary Note 6)

The collation method according to Supplementary note 5, further including

(c) a step of adjusting the number of first feature points.

(Supplementary Note 7)

The collation method according to Supplementary note 6, wherein in the (c) step, the number of first feature points is adjusted using the arithmetic unit other than the vector-type arithmetic unit.

(Supplementary Note 8)

The collation method according to any one of Supplementary notes 5 to 7, wherein the collation method is used for biometric authentication.

(Supplementary Note 9)

A computer readable recording medium that includes recorded thereon:

(a) a first program including instructions that cause a vector-type arithmetic unit to carry out a step of calculating first similarity degrees using first feature points extracted from a target biological image and second feature points in a plurality of registered biological images, and narrowing down the registered biological images based on the calculated first similarity degrees; and

(b) a second program including instructions that cause an arithmetic unit, other than the vector-type arithmetic unit, to carry out a step of calculating second similarity degrees using third feature points extracted from the target biological image and fourth feature points in the registered biological images obtained by the narrowing-down, and specifying a registered biological image based on the calculated second similarity degrees.

(Supplementary Note 10)

The computer readable recording medium according to Supplementary note 9, further having recorded thereon

(c) a program including instructions that cause a step of adjusting the number of first feature points to be carried out.

(Supplementary Note 11)

The computer readable recording medium according to Supplementary note 10, wherein in the (c) step, the number of first feature points is adjusted using the arithmetic unit other than the vector-type arithmetic unit.

(Supplementary Note 12)

The computer readable recording medium according to any one of Supplementary notes 9 to 11, wherein

the first and second programs are used for biometric authentication.

The invention has been described with reference to an example embodiment above, but the invention is not limited to the above-described example embodiment. Within the scope of the invention, various changes that could be understood by a person skilled in the art could be applied to the configurations and details of the invention.

### INDUSTRIAL APPLICABILITY

As described above, according to the invention, the time required for collation processing can be reduced using a vector processor. The invention is useful in fields in which collation such as biometric authentication is necessary.

### REFERENCE SIGNS LIST

1 Collation apparatus

2 Vector-type arithmetic unit

3 Arithmetic unit

20 System

21 Image capturing apparatus

22 Similarity degree calculation unit

23 Narrow-down unit

24 Feature extraction unit

25 Similarity degree calculation unit

26 Specifying unit

27 Feature point adjustment unit

31, 32a, 32b, 32c, 32d, 32e Feature point information

51, 52a, 52b, 52c, 52d Feature point information

110 Computer

111 Vector processor

112 Main memory

113 Storage device

114 Input interface

115 Display controller

116 Data reader/writer

117 Communication interface

118 Bus

120 Computer

121 Processor

122 Main memory

123 Storage device

124 Input interface

125 Display controller

126 Data reader/writer

127 Communication interface

128 Input equipment

129 Display device

130 Recording medium

131 Bus

What is claimed is:

1. A collation apparatus comprising:
a vector-type arithmetic unit configured to calculate first similarity degrees using first feature points extracted from a target biological image and second feature points in a plurality of registered biological images, and narrow down the registered biological images based on the calculated first similarity degrees; and
an arithmetic unit, other than the vector-type arithmetic unit, configured to calculate second similarity degrees using third feature points extracted from the target biological image and fourth feature points in the registered biological images obtained by the narrowing-down, and specify a registered biological image based on the calculated second similarity degrees.

2. The collation apparatus according to claim 1, further comprising
a feature point adjustment unit configured to adjust the number of first feature points.

3. The collation apparatus according to claim 2, wherein
the arithmetic unit includes the feature point adjustment unit.

4. The collation apparatus according to claim 1, wherein the collation apparatus is used for biometric authentication.

5. A collation method comprising:
using a vector-type arithmetic unit to calculate first similarity degrees using first feature points extracted from a target biological image and second feature points in a plurality of registered biological images, and narrow down the registered biological images based on the calculated first similarity degrees; and
using an arithmetic unit, other than the vector-type arithmetic unit, to calculate second similarity degrees using third feature points extracted from the target biological image and fourth feature points in the registered biological images obtained by the narrowing-down, and specify a registered biological image based on the calculated second similarity degrees.

6. The collation method according to claim 5, further comprising adjusting the number of first feature points.

7. The collation method according to claim 6, wherein
the number of first feature points is adjusted using the arithmetic unit other than the vector-type arithmetic unit.

8. The collation method according to claim 5, wherein
the collation method is used for biometric authentication.

9. A non-transitory computer readable recording medium that includes recorded thereon:
a first program including instructions that cause a vector-type arithmetic unit to carry out a step of calculating first similarity degrees using first feature points extracted from a target biological image and second feature points in a plurality of registered biological images, and narrowing down the registered biological images based on the calculated first similarity degrees; and
a second program including instructions that cause an arithmetic unit, other than the vector-type arithmetic unit, to carry out a step of calculating second similarity degrees using third feature points extracted from the target biological image and fourth feature points in the registered biological images obtained by the narrowing-down, and specifying a registered biological image based on the calculated second similarity degrees.

10. The non-transitory computer readable recording medium according to claim 9, further having recorded thereon
a program including instructions that cause a step of adjusting the number of first feature points to be carried out.

11. The non-transitory computer readable recording medium according to claim 10, wherein
the number of first feature points is adjusted using the arithmetic unit other than the vector-type arithmetic unit.

12. The non-transitory computer readable recording medium according to claim 9, wherein
the first and second programs are used for biometric authentication.
